(19) United States
(12) Patent Application Publication
(10) Pub. No.: US 2019/0370463 A1
(43) Pub. Date: Dec. 5, 2019

(54) SECURITY DEVICE

(71) Applicant: EXACTTRAK LIMITED, Oxfordshire (GB)

(72) Inventors: John Pragnell, Oxfordshire (GB); Norman Shaw, Oxfordshire (GB)

(21) Appl. No.: 16/477,857

(22) PCT Filed: Jan. 19, 2018
(86) PCT No.: PCT/GB2018/050174

§ 371 Date: Jul. 12, 2019

(30) Foreign Application Priority Data
Jan. 19, 2017 (GB) 1700956.4

(51) Int. Cl. G06F 21/55; G06F 21/74; G06F 21/57; G06F 9/4401

(52) U.S. Cl. CPC G06F 21/554; G06F 21/74; G06F 2221/033; G06F 9/441; G06F 21/575

(57) ABSTRACT

There is described a computing device, a method of operating a computer device, a tangible non-transitory computer-readable medium, a computer product and an apparatus. The described computing device having a memory and a processor, the processor configured with a first operating system and a second operating system. The first operating system is configured to support a plurality of first applications and to provide access to encrypted data for the second operating system. The first operating system is configured to monitor data operations performed by the plurality of first applications and to trigger a security action in the event that one or more of the plurality of first applications perform an unallowable operation.

### FIELD OF INVENTION

This invention relates to methods and apparatus associated with security of computing devices which may be enforced using secure operating systems.

### BACKGROUND

The advent of computing devices has led to a wide range of such devices being developed, and used in a huge variety of circumstances.

People use these devices in their everyday life. For example at home a person may use their personal computer, laptop or tablet. On public transport they may use an e-reader device and their mobile phone and at work they may use a work computer that is configured to remain in the office at all times.

Each of these devices will be used to assist the user with a variety of different tasks. Some of these devices will be designed to assist with the same tasks as other devices. Each device has its own limitations and its own security risks.

### SUMMARY

Aspects of the invention are set out in the independent claim and optional features are set out in the dependent claims.

A first aspect provides a computing device having a memory and a processor configured with:

a first operating system and a second operating system wherein the first operating system is configured to support a plurality of first applications and to provide access to encrypted data for the second operating system,

wherein the first operating system is configured to monitor data operations performed by the plurality of first applications and to trigger a security action in the event that one or more of the plurality of first applications perform an unallowable operation.

This may allow the protection of data security because the user's operating system can only access data through the decryption source, but with increased flexibility because the first operating system can securely support applications and securely enforce them. This may allow the computing device to stop unwanted operations being performed by the first applications. This means that the distribution of data stored in the first memory can be more readily controlled, making it more secure.

The first operating system may be protected in that it may only be altered or updated by remote commands received from specific devices. For example, the computing device may further comprise a wide area communication interface configured to receive a message from a remote device. The first operating system may be configured to trigger a security action in the event that the remote device is designated as unallowable.

This may enable the first applications and first operating system to be updated or changed without a user directly interacting with it. Instructions can therefore be readily relayed to the first operating system in this manner.

Alternatively or in addition, the computing device may further comprise a location determiner configured so that the device can determine its current location and the first operating system is configured to trigger a security action in the event that the location is designated as unallowable.

Embodiments of the disclosure may enable users to use a single device in more locations and to perform more tasks without the device's security being comprised.

Embodiments of the present disclosure may enable a user to use a single device in multiple contexts, where normally they would require two or more devices. This may allow employees may bring their home laptops to work, thus negating the need for a work computer. Embodiments of the present disclosure result in the confidential information from the workplace being accessible if the laptop is brought to work, or if the work server sends an authorising message, or if a security action is not triggered. This can contextualise the use of the device. The same device can be used at home, but without access to work files, and therefore function solely as a personal computer, but at work it can function as a work computer. This enhances the security of the device and will encourage more flexible working.

Embodiments of the disclosure relate to personal computers, portable computers, and other computing devices. Examples of computing devices include laptops, tablets, personal computers, mobile phones, e-reader devices, mp3 players, hard disc drives and other devices containing a memory and a processor.

### FIGURES

Embodiments of the disclosure will now be described, purely by way of example, with reference to the accompanying drawings, in which:

FIG. 1 shows an overview of a computing device.

FIG. 2 shows a conceptual block diagram of a computing device representing both hardware and computer architecture constructs.

FIG. 3 shows an algorithm for detecting non-allowable applications.

FIG. 4 shows an algorithm for detecting non-allowable requests of resources for applications.

FIG. 5 shows an algorithm for detecting if a remote device is allowable.

FIG. 6 shows an embodiment in which the computing device of FIG. 2 contains a wide area communication interface.

FIG. 7 shows an embodiment in which the computing device of FIG. 2 contains a location determiner.

### DETAILED DESCRIPTION OF EMBODIMENTS

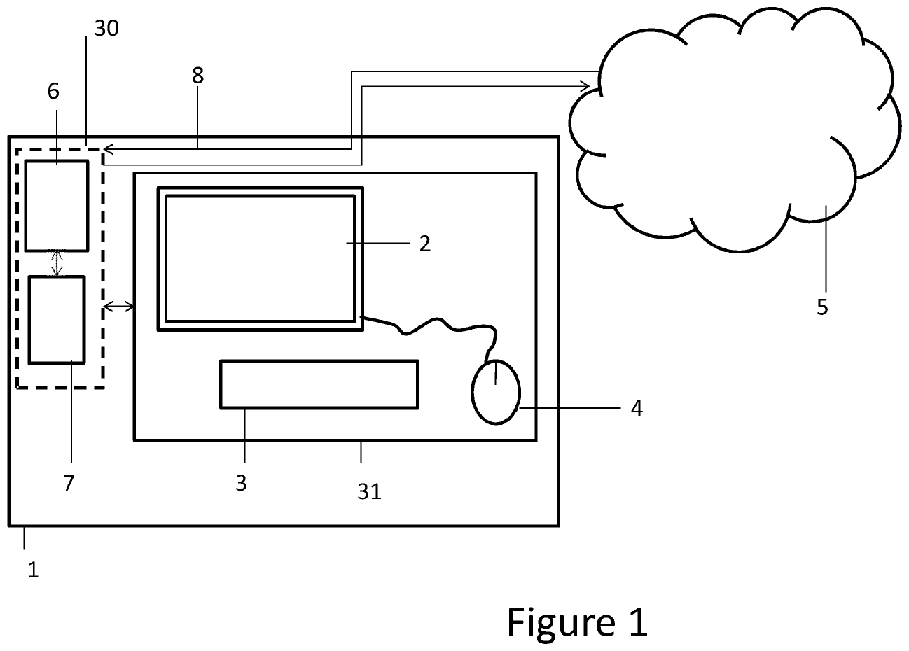

FIG. 1 shows a computing device 1 connected to a network 5.

The computing device comprises a user interface coupled to a processor and a memory. The computing device is configured to provide enhanced security and control by encrypting data, and controlling the encryption and decryption of that data as explained below.

The user interface may comprise a monitor 2, keyboard 3, and mouse 4. The user interface is configured to obtain input from a human user (not shown) of the computing device and to provide output signals to that user. The user interface may comprise any one or more of the above described human input output devices, or other such devices.

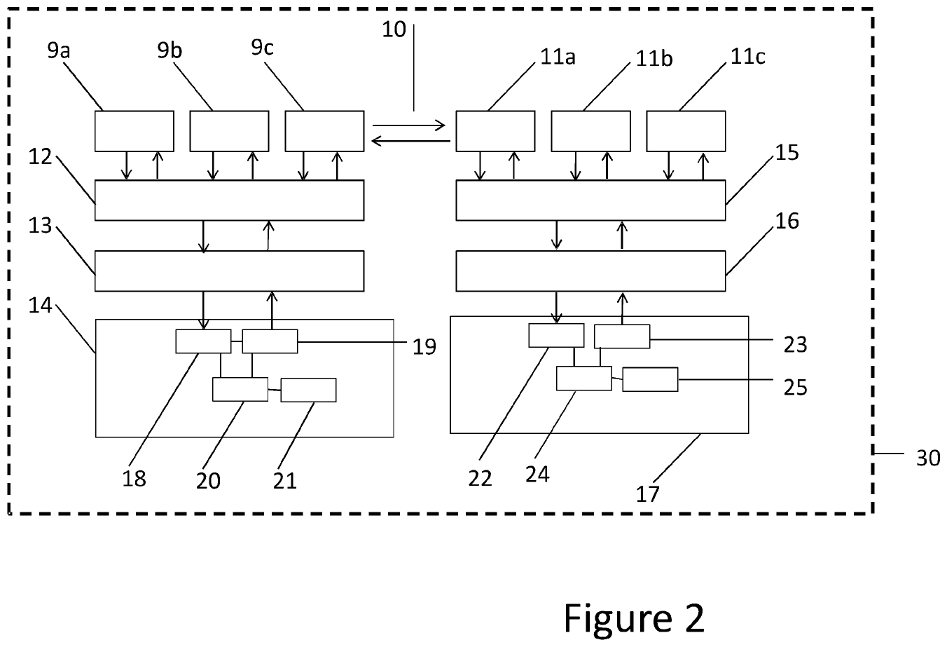

The computing device 1 (e.g. its processor and memory together) is configured to run software and firmware such as an operating system and applications. It will be appreciated that functionality of such computer architecture constructs 30 may be provided solely or partially in hardware and solely or partially in software/firmware. It is for this reason that these constructs are indicated generally together by the dashed box 30 in FIG. 1. These constructs 30 are explained in more detail below with reference to FIG. 2. The computing device is also configured to send and receive data over the network.

The network is operable to communicate between the computing device and other remote computer devices (not shown in FIG. 1). The network may comprise wired or wireless communication elements and may be configured for packet switched network communications which may be mediated using protocols such as TCP/IP and other communications protocols.

In operation the processor and memory are configured to run a first operating system and a second operating system and to run them concurrently. The operating systems are explained below with reference to FIG. 2. The first operating system however is configured to control the decryption of data for the second operating system. It is also configured to monitor data operations performed by applications running in that first operating system and to trigger a security action in the event that any of those first applications perform an unallowable operation.

It will be appreciated in the context of the present disclosure that, in some circumstances, the user of the computing device can alter some or all of software or data that is stored on the computing device. This depends on the hardware and computer architecture constructs that comprise the computing device. If this occurs they can change a large amount of data and/or software that could decrease or change the functionality of the computer device.

Data received from the network can represent a security threat as it may contain malware, viruses or other software that is designed to alter the computing device in some way. The computing device can be vulnerable to such an attack.

Described below are embodiments that mitigate against damage caused by software received from a network and against damaged caused by an unwanted or rogue user.

FIG. 2 shows a block diagram representing computer hardware/firmware/software constructs 30 such as those discussed above with reference to FIG. 1.

The computing device illustrated in FIG. 2 comprises first hardware 17 and second hardware 14.

The first hardware comprises a first input communication interface 22, a first output communication interface 23, a first processor 24 and a first memory 25. The first input communication interface is coupled to both the first processor and the first memory. The first output communication interface is coupled to both the first processor and the first memory. The first memory and first processor may be coupled to one another.

The first hardware is configured to support a first kernel and scheduler 16. The first kernel and scheduler is configured to support a first operating system 15. The first operating system is configured to support a plurality of first applications 11a-c.

The first kernel and scheduler is configured to receive data from the first output communication interface and is configured to send data to the first input communication interface.

The second hardware comprises a second input communication interface 18, a second output communication interface 19, a second processor, 20 and a second memory 21. The second input communication interface is coupled to both the second processor and the second memory. The second output communication interface is coupled to both the second processor and the second memory. The second memory and second processor may be coupled to one another.

The second hardware is configured to support a second kernel and scheduler 13. The second kernel and scheduler is configured to support a second operating system 12. The second operating system is configured to support a plurality of second applications 9a-c.

The second kernel and scheduler is configured to receive data from the second output communication interface and is configured to send data to the second input communication interface.

The second operating system is configured to act substantially as a normal operating system would. The first operating system however, is configured to have more limited functionality.

The plurality of first applications is coupled to the plurality of second applications through communications channel 10.

The second applications are configured to perform a group of co-ordinated functions, tasks or activities at the request of the user. The first applications are configured to perform tasks set by the second applications that the second applications do not have the capability to perform, such as decryption. A task can be any data operation.

As stated above, the second operating system is configured to function as a normal operating system. It is therefore configured to perform basic tasks, such as recognizing input from the keyboard, sending output to the display screen, keeping track of files and directories on the disk, ensure program execution, and controlling peripheral devices such as disk drives and printers. In some embodiments, the second kernel and scheduler can comprise part of the second operating system.

The first operating system is configured to ensure program execution and monitor the first applications. This is more limited than the functionality of the second operating system. In some embodiments, the first kernel and scheduler can comprise part of the first operating system. The first operating system may also allocate memory resources for each first application. Each first application may have a memory space. In some embodiments the operating system may monitor for any application attempting to use memory resources outside of its own memory space. For example the first operating system may monitor the memory resources requested by applications. If these are outside of an application's assigned memory space this may result in the action being reported and blocked.

The kernels and schedulers are configured to assign resources such as processor and memory resources to tasks and data. This functionality can include loadbalancing and multitasking as well as virtual addressing. These functions may be performed on behalf of the operating systems, or the kernels and schedulers may be part of the operating systems.

The first operating system is configured to support a plurality of first applications and to provide access to encrypted data for the second operating system. The first operating system is configured to monitor data operations performed by the plurality of first applications and to trigger a security action in the event that one or more of the plurality of first applications perform an unallowable operation.

The first and second kernel and schedulers are configured so that the plurality of first applications and the plurality of second applications can run simultaneously. A single scheduler can be configured for this purpose.

Data operations may comprise the movement of data between the plurality of first applications. This may include monitoring if an application attempts to access, or use, memory space in the first memory that is not assigned to it.

Monitoring the data operations may comprise comparing data operations performed by the first applications to a list of data operations stored in the memory.

The first operating system may be configured to stop any data operation that is proscribed.

The first and second hardware may comprise a tangible, non-transitory computer-readable medium. This medium may support the kernels and schedulers, operating systems and applications in the same manner described above.

The first operating system is configured to provide access to encrypted data for the second operating system. This can be through use of communication channel 10. For example, it may be the case that the first memory has a key stored to decrypt a set of encrypted data stored in the second memory. The second application then sends the encrypted data to the first application where it is decrypted using the key. The first application then sends the decrypted data back to the second application where the newly decrypted data can be used, or stored in the second memory.

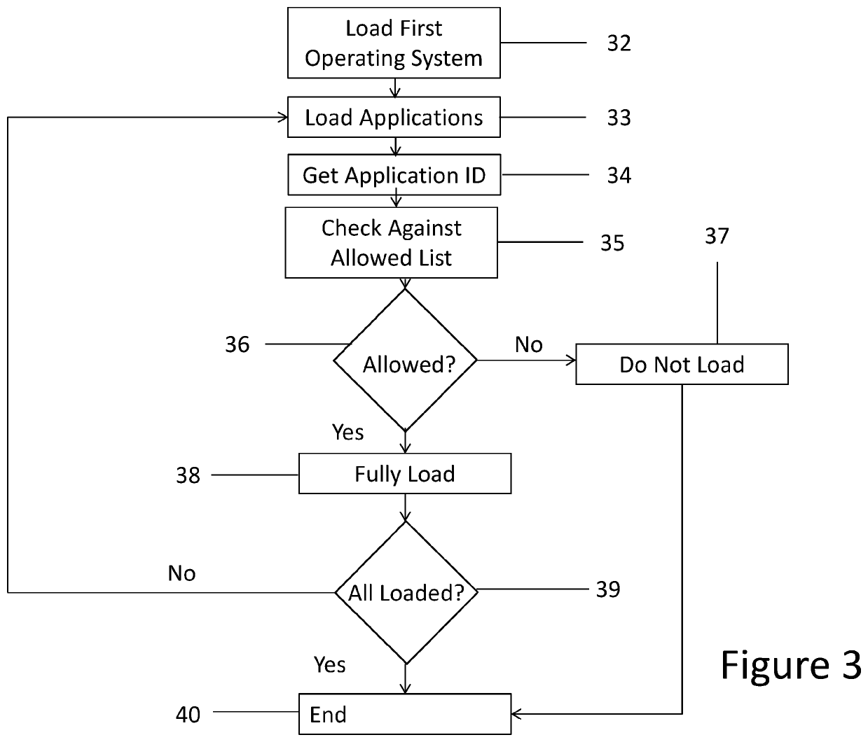

The computing device of FIG. 2 may be used for detecting, upon switching on the computing device, if all the applications are loaded and if all the applications are allowed. One algorithm that may be implemented to achieve this is shown in FIG. 3. Step 32 shows that upon switching on the computing device the first operating system is loaded. Step 33 then loads all of the applications. In step 34 the first operating system reads the application identification of all of the applications. Step 36 shows the application ID's being compared to a list of allowed applications to see if all of the applications are allowed. This list may be stored on the memory. If the applications are designated as allowed the applications are fully loaded at step 38. The first operating system then checks that all the applications have loaded at step 39. If this is the case the algorithm comes to an end. If it is not the case then the applications are reloaded and the process begins once more. If an application is not designated as allowed then the application is not loaded as shown in step 37. This is then the end of the algorithm. This algorithm protects the first operating system because it means that every time the computing device is switched on only allowed applications are fully loaded. Unallowed, or foreign, applications may present a risk to the security of the first operating system and therefore the algorithm reduces this risk.

The first operating system is configured to monitor data operations performed by the first applications. The first operating system is configured to trigger a security action in the event that a first application performs an unallowable data operation. A data operation is any task that the first application performs that involves data. It can include encryption and decryption set by a second application. One data operation that may be unallowable is communication between two or more first applications. This can be undesirable. Therefore the first operating system may monitor for the movement of data between a plurality of first applications. The first operating system is configured to stop any data operation that is proscribed. Another example of a potentially unallowable data operation would be for a first application to request more than its allotted number of clock cycles from the processor in a specific amount of time. This would mean that one application would be able to commandeer most of the processors resources and so regulating this means that one application cannot overload the first operating system.

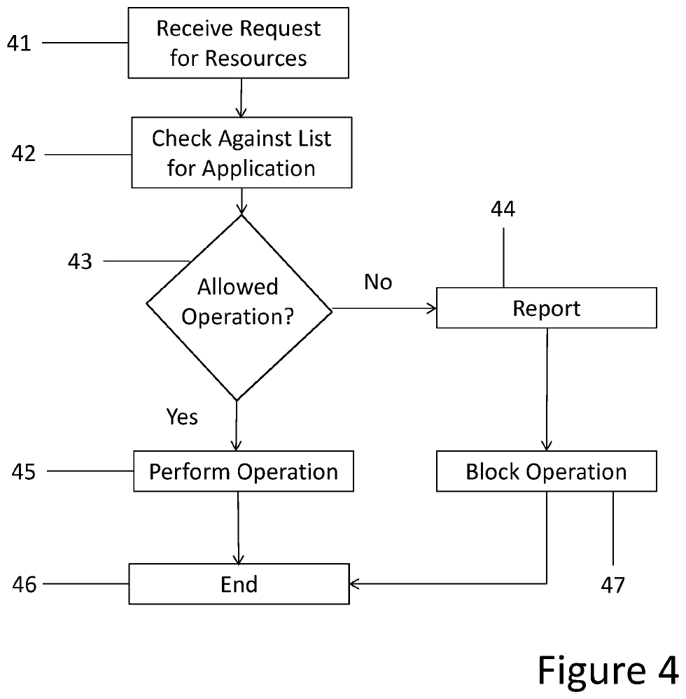

FIG. 4 shows an algorithm for detecting if a first application attempts to perform an unallowed operation. The first operating system receives a request for resources from a first application at step 41. This request is then checked against a list of allowed requests for resources in step 42. This list may be stored on the memory. The first operating system then determines if the operation is allowed at step 43. If the operation is allowed then the resources are allocated and the operation is performed at step 45. This is the end of the algorithm. If the operation is not allowed this is reported at step 44. The operation is blocked and not given resources at step 47. This is the end of the algorithm. The first operating system may act on the report to further investigate why an application has requested unallowed resources. This may lead to a further a security action that could include the application requesting the resources being designated unallowable. It is also possible that this will result in no further action. This algorithm allows the first operating system to detect unallowed operations. This may be two first applications communicating with one another. If this operation is not allowed then it will be blocked.

In some embodiments a user of the computing device has access to the second operating system of FIG. 2. Through this they can utilise the second applications. In some embodiments the user cannot however manipulate the first operating system. Edit the first operating system or the first applications in any way may be inhibited. These first applications can be used by the second applications for performing tasks, such as encryption or decryption.

In FIG. 2 the first and second kernels and schedulers are used so that the tasks performed by the first and second applications can be relayed into data processing instructions and assigned resources in the first and second hardware. The first scheduler is configured so that the first applications and the second applications can be run simultaneously. This means that whilst a second application is running on the computing device a first application can run in the background, without halting the progress of the second application. This can be achieved by having two processors, such as the first processor and second processor, running in parallel. This is advantageous as it means that the user does not have to relinquish control of the computing device whilst a task is carried out by a first application.

A tangible, non-transitory computer-readable medium may be configured for performing the steps, acts and algorithms described above.

There are a number of alternative configurations of the physical hardware that fall within FIG. 2. For example the components of first hardware and second hardware may be combined or they may be entirely separate. A quad core processor in a computing device may have one core specified as being the first processor and the other three as comprising the second processor. Alternatively separate processors may be provided for the first and second processors. The first and second memory may be one memory storage device that is partitioned so that only the first processor can access the first part of the memory device and the only the second processor can access the second part of the memory device. Alternatively there may be two distinct memory storage devices, the first memory and the second memory. There may be only one kernel and scheduler for both the first and second applications that is configured so that the first applications and second applications can run simultaneously. Alternatively there may be two distinct kernels and schedulers configured so that the first applications and second applications can run simultaneously. Additionally the first operating system may have access to the second hardware. However, in some embodiments, the second operating system cannot have access to the first hardware.

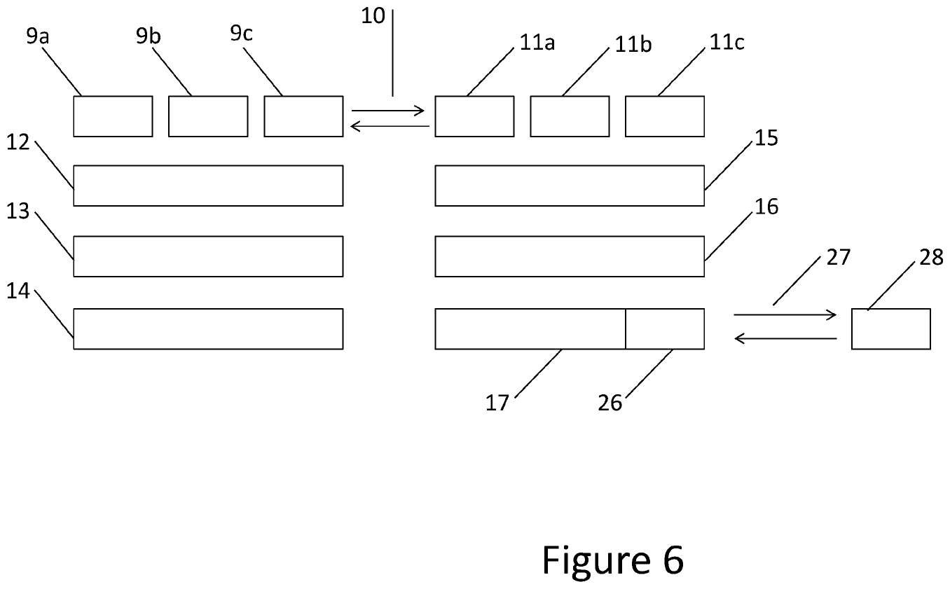

FIG. 6 shows another embodiment of the computing device. The first hardware in FIG. 6 further comprises a wide area communication interface 26 that is coupled to a remote device 28 by communication channel 27. The computing device may further comprise an alteration controller (not shown). This may be incorporated in part of the first operating system, or it may form a first application supported by the first operating system. Alternatively it may be implemented in the physical hardware of the computing device, such as in the first processor.

FIG. 6 has been simplified to not show all of the communication between the different components of the computing device. This is purely to simplify the diagram; however the interactions remain the same as shown in FIG. 2. Further the components of the first and second hardware have been removed from the diagram for simplicity. These components are still however present in the hardware of FIG. 6.

The wider area communication interface is configured to receive messages from the remote device. This communication can be performed through communication channel 27. The wide area communication interface may further be able to send messages to the remote device. This communication can be performed through the communication channel.

The first operating system may be configured to trigger a security action in the event that the remote device is designated as unallowable.

The security action may be to discard the message received from the remote device.

The computing device may further comprise an alteration controller configured to reject alteration of the first operating system unless the alteration is based on the message received. In some embodiments the alteration controller maybe part of the operating system.

The alteration of the first operating system may be rejected unless the remote device that sent the message is designated as allowable.

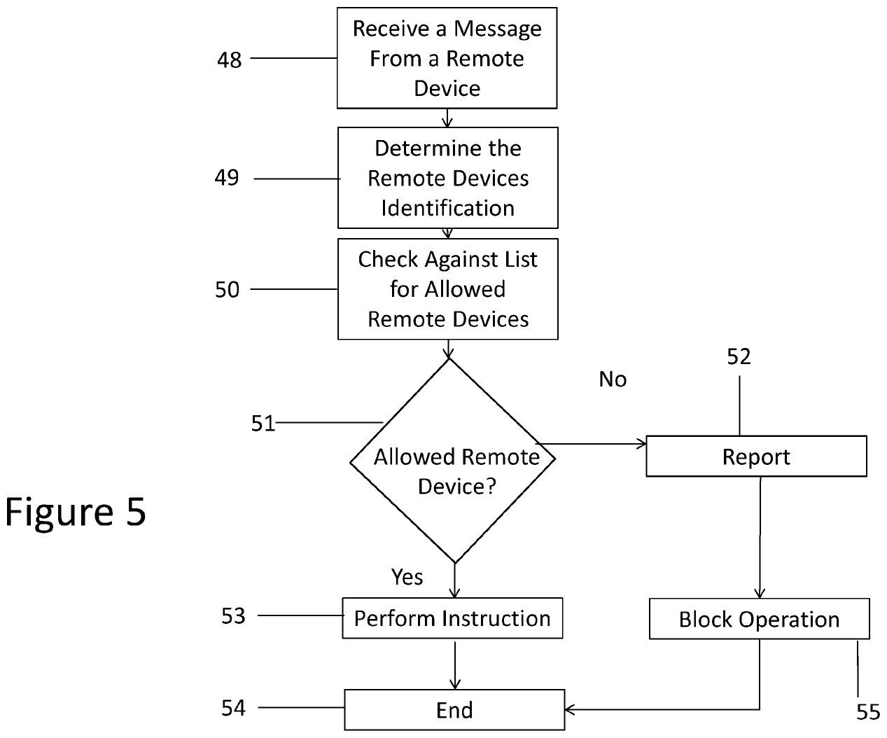

A method of checking whether a remote device is allowed to instruct the first operating system to perform instructions is shown in FIG. 5. A message is received by the first operating system from a remote device in step 48. The first operating system then determines the remote devices identification. This is then checked against a list of allowed remote device in step 50. This list may be stored in the first memory. Step 51 shows the first operating system determining if the remote device is allowed or not. If it is, the instruction contained in the message is performed by the first operating system. This is the end of the process. If not then the unallowed remote device is reported and the instructions are not carried out and any operation they pertained to is blocked. This method ensures that unallowed remote devices may not be able to instruct the first operating system to perform any operation.

The first operating system is configured to trigger a security action in the event that the remote device is designated as unallowable. If a message is received without identifying where the message is from it may be designated as unallowable. Alternatively if the sender of the message is identified then this identity can be compared to a list of allowed remote devices. If the sender of the message is not on the list of remote device the security action may be triggered. This security action may include discarding the message. It may also include powering off the wide area communications interface or sending a message to an approved remote device. This can be especially useful if a substantial amount of messages are sent to the wider area interface to the extent that they inhibit the computing devices ability to check that each message comes from an allowable source. Other security actions may include powering off the entire computing device or suspending all tasks performed by the first applications. This can be done by setting all tasks to be unallowable. Any action can be performed for a specified amount of time, or indefinitely. It may be that a security action, such as suspending all data operations performed by the first applications, may continue until a message is received from an approved remote device.

The message received by the wide area communication interface can have a variety of uses. For example it can be used to alter the first operating system or a first, or several first, applications. This could be to perform updates to these systems or to add additional functionality. The message may also be able to change what tasks are considered allowable for an application, or what memory a first application has access to. The message may also be used to delete an application. In some embodiments the alteration controller is configured to reject alteration of the first operating system unless such an alteration is based on a received message from an approved remote device.

The message may alternatively be sent to the wide area communication device at regular intervals. The lack of a message in this case would trigger a security action. In this case the message itself may not have a purpose other than informing the computing device not trigger a security action.

The remote device may also replace the list of allowable data operations stored in the memory. The computing device may send a message asking a remote device if a data operation is allowed and then trigger a security action in the event that the remote device sends a message saying that the task is unallowable (or alternatively if one is not sent detailing the task to be allowable). The remote device may send a message with a list of allowed data operations for each first application. This may be sent at regular intervals.

The use of a wide area communications interface allows the computing device to update or alter the first operating system and first applications without allowing the user of the computing device such control. This means that a computing device can be given to a user without the user the user being able to access all of the data stored on the device.

This can be very useful for jobs that involve complex tasks but a high amount of security and secrecy as an employee can be given a computing device without the risk of them gathering unallowable data. It also means that if a computing device containing confidential information is lost any information stored in the first memory is not at risk of being found by someone without permission to view it. The remote device could send the wide area communication interface a message instructing it to stop the start-up process of the computing device. This could disable the device in the event that it is lost, stolen, or if, for example, an employee's employment is terminated. The start-up process may be one of a boot sequence, the loading of the second operating system, the loading of the second applications, the ability of the second applications, or operating system, to access hardware of the computing device, or powering the hardware of the computing device.

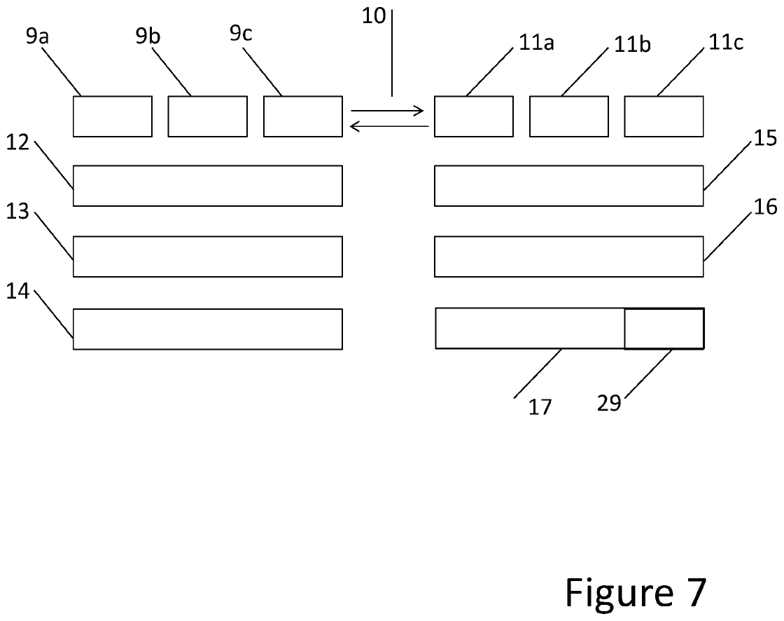

FIG. 7 shows another embodiment of the computing device in which the wide area interface (as shown in FIG. 6) has been replaced with a location determiner 29.

In other embodiments a computing device may have both a location determiner and a wide area communication interface. FIG. 7 only shows the location determiner for simplicity. The location determiner may comprise a GPS transceiver.

The location determiner can determine its current location, and therefore the location of the computing device. The computing device can trigger a security action in the event that the location is designated as unallowable.

The first operating system may be responsible for triggering the security action in response to the location being determined by the location determiner. The security action can be to disable the data operations of the first applications, delete data stored in the first memory, power off the computing device or send a message to a remote device. This message may include asking what further security action the computing device should perform and stopping operations of the second hardware. A list of allowable locations or a list of unallowable locations can be stored in the first memory and this can be compared with the location determined by the location determiner in order to determine if a security action should be triggered.

In addition to this the location determiner can pass recently determined locations to the processor so that the route, or approximate route, the computing device is taking can be determined. A route may be designated as unallowable, or only certain routes may be designated as allowable. A security action may be triggered by the first operating system in the event that a route is taken that is not allowable, or a route is taken that is unallowable. The security action may be the same as in the paragraph above.

Rather than comparing a location or a route to a list of allowed, or unallowable locations or routes, the wide area interface may send a remote device a message asking if a location or route is allowable. A security action would then be triggered if the remote device sends a message stating that the location or route is unallowable, or if it does not send a message stating that the location or route is allowable.

In one embodiment the location determiner may determine the location at periodic intervals in order to be energy efficient. It may also have its own power supply so that it can determine the location of the computing device at all times.

In a further embodiment according to the computing device described in any of FIG. 2, 6 or 7 upon the computing device gaining power, the start-up process of the computing device may be controlled. This may be done by controlling the boot sequence, the loading of the second operating system, the loading of the second plurality of application, of whether to allow the second applications access to hardware, of the powering of the hardware of the computing device.

The start-up process control may be based on the monitoring of data operations by the operating system. Alternatively it may be based on a message received from a remote device. Alternatively it may be based on the location determined by the location determiner.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

It will be appreciated in the context of the present disclosure that an operating system (OS) may comprise system software that manages computer hardware and software resources and provides common services, such as access to those resources for computer programs. An example of an operating system is a time-sharing operating system. Such operating systems may schedule tasks to be performed by the computer's hardware or software resources. For hardware functions such as input and output and memory allocation, an operating system may act as an intermediary between programs and the computer hardware. Software application code may be executed directly by the hardware, but may also make system calls to an OS function or may be interrupted by it.

Different types of operating system exist. A single-tasking operating system may be able to only run one program at a time, while a multi-tasking operating system may allow more than one program to be running concurrently. This may be achieved by time-sharing, dividing the available processor time between multiple processes that are each interrupted repeatedly in time slices by a scheduler which may be a task-scheduling subsystem of the operating system. Multi-tasking may be characterized as either pre-emptive or co-operative. In pre-emptive multitasking, the operating system slices the CPU time and dedicates a slot to each of the application programs. Cooperative multitasking may be achieved by relying on each process to provide time to the other processes in a defined manner.

A scheduler may be a part of an operating system that is configured to decide which process (e.g. a service or task to be performed for an application program running on the operating system) may run at a certain point in time. A scheduler may have the ability to pause a running process, move it to the back of the running queue, start a new process, or perform other scheduling tasks.

A kernel of an operating system, with the aid of the firmware and device drivers, may provide the most basic level of control over all of the computer's hardware devices. It may manage memory access for programs in the RAM, and may determine which programs get access to which hardware resources.

Embodiments of the present disclosure provide computer program products, and tangible non-transitory storage media. Such products and storage media may comprise program instructions configured to program a processor, such as a CPU, of a computing device to perform any one or more of the methods described or claimed herein. For example they may program a processor of a computing device to provide two operating systems having any one or more of the features of such systems (kernel, scheduler etc.) described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein.

The activities and apparatus outlined herein may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

1. A computing device having a memory and a processor configured with:
a first operating system and a second operating system wherein the first operating system is configured to support a plurality of first applications and to provide access to encrypted data for the second operating system,
wherein the first operating system is configured to monitor data operations performed by the plurality of first applications and to trigger a security action in the event that one or more of the plurality of first applications perform an unallowable operation.

2. The computing device of claim 1 further comprising a scheduler and wherein the second operating system is configured to support a plurality of second applications and wherein the scheduler is configured so that the plurality of first applications and the plurality of second applications can run simultaneously.

3. The computing device of claim 1 or 2 wherein data operations comprise the movement of data between the plurality of first applications.

4. The computing device of any preceding claim wherein monitoring the data operations comprises comparing data operations performed by the first applications to a list of data operations stored in the memory.

5. The computing device of any preceding claim wherein the first operating system is configured to stop any data operation that is proscribed.

6. The computing device of any previous claim further comprising a wide area communication interface configured to receive a message from a remote device.

7. The computing device of claim 6 wherein the first operating system is configured to trigger a security action in the event that the remote device is designated as unallowable.

8. The computing device of claim 7 wherein the security action is to discard the message received from the remote device.

9. The computing device of claim 6 comprising an alteration controller configured to reject alteration of the first operating system unless the alteration is based on the message.

10. The computing device of claim 9 wherein the alteration of the first operating system is rejected unless and the remote device that sent the message is designated as allowable.

11. The computing device of any of the previous claims further comprising a location determiner configured so that the device can determine its current location and configured to trigger a security action in the event that the location is designated as unallowable.

12. The computing device of any previous claim wherein at least one of the plurality of first applications is configured to control the start-up process of the computing device.

13. The computing device of claim 12 wherein the start-up process is one of:
a boot sequence;
loading of the second operating system;
loading of the plurality of second applications;
allowing the plurality of second applications access to hardware of the computing device;
powering the hardware of the computing device.

14. A method of operating a computing device, wherein the computing device comprises a processor running a first operating system and a second operating system, wherein the first operating system is configured to support a plurality of first applications, wherein the first applications are configured to perform data operations requested by the second operating system, wherein the first operating system:
runs a plurality of first applications;
receives decryption requests from the second operating system;
decrypts encrypted data;
sends the requested decrypted data to the second operating system;
whilst concurrently monitoring the data operations performed by the first applications; and
in the event that the data operation is designated as allowable allowing the data operation to be performed, and in the event that it is not designated allowable blocking the performance of the data operation.

15. A method of operating a computing device, wherein the computing device comprises a processor running a first operating system and a second operating system and a wide area communication interface configured to receive messages containing instructions from a remote device, wherein the first operating system:
receives a message form a remote device;
determines the identity of the remote device;
compares the identity of the remote device to a list of allowed remote devices;
performing the instruction in the event that the remote device is an allowed remote device and not performing the instruction in the event that the remote device is not an allowed remote device.

16. A method of operating a computing device, wherein the computing device comprises a processor running a first operating system and a second operating system and a location determiner configured to determine the location of the computing device, wherein the first operating system:
receives the location of the computing device;
compares the location of the computing device to a list of allowable locations;
performing a security action in the event that the location is not designated as allowable, and performing no action in the event that the location is allowable.

17. The method of claim 16 wherein the security action is to control the start-up process of the computing device.

18. The method of claim 17 wherein the start-up process is one of:
a boot sequence;
loading of the second operating system;
loading of the plurality of second applications;
allowing the plurality of second applications access to hardware of the computing device;
powering the hardware of the computing device.

19. A tangible, non-transitory computer-readable medium configured to perform any of the method claims 14-18.

20. A computer program product configured to perform any of the method claims 14-18.

21. A tangible, non-transitory computer-readable medium configured with:
a first operating system and a second operating system wherein the first operating system is configured to support a plurality of first applications and to provide access to encrypted data for the second operating system,
wherein the first operating system is configured to monitor data operations performed by the plurality of first applications and to trigger a security action in the event that one or more of the plurality of first applications perform an unallowable operation.
